(19) United States
(12) Patent Application Publication
(10) Pub. No.: US 2025/0294103 A1
(43) Pub. Date: Sep. 18, 2025

(54) IMAGE READING DEVICE

(71) Applicant: SEIKO EPSON CORPORATION, TOKYO (JP)

(72) Inventors: Hiroyuki TAJIMA, KITAKYUSHU-SHI (JP); Masaki NAMIKI, KITAKYUSHU-SHI (JP)

(21) Appl. No.: 19/080,796

(22) Filed: Mar. 15, 2025

(30) Foreign Application Priority Data
Mar. 15, 2024 (JP) 2024-040900

(51) Int. Cl. H04N 1/00

(52) U.S. Cl. CPC H04N 1/00588; H04N 1/00591

(57) ABSTRACT

An image reading device includes: a first reading unit including a reading surface for reading a first surface of a medium transported through a transport path in a transport direction; a second reading unit disposed downstream of the first reading unit and configured to read a second surface; a first transport roller pair disposed upstream of the first reading unit and configured to transport the medium; and a second transport roller pair disposed between the first reading unit and the second reading unit and configured to transport the medium, in which a tangent-line direction at a first nipping position at which the first transport roller pair nips the medium heads toward a position upstream of the reading surface of the first reading unit in the transport direction, and a tangent-line direction at a second nipping position at which the second transport roller pair nips the medium heads toward a position upstream of the reading surface of the second reading unit in the transport direction.

The present application is based on, and claims priority from JP Application Serial Number 2024-040900, filed Mar. 15, 2024, the disclosure of which is hereby incorporated by reference herein in its entirety.

### BACKGROUND

### 1. Technical Field

The present disclosure relates to an image reading device.

### 2. Related Art

One example of this type of the device includes an image reading device described in JP-A-2014-51338. JP-A-2014-51338 describes the following matters.

Two imaging units are disposed so as to face each other. A transport roller pair has an oppositely curled structure, and is configured to transport a medium relative to these imaging units.

The image reading device described in JP-A-2014-51338 is configured such that the center of a first driven roller is disposed so as to be positionally shifted more toward the first imaging unit side than the center of the first transport roller. Thus, the leading end of the sheet is transported along a glass surface of the first imaging unit. However, as the sheet is transported so as to be away from a glass surface of the second imaging unit, there is a problem in which the quality of an image at an opposite side of the sheet deteriorates.

In addition, there is no description nor suggestion as to the configuration in which the two imaging units are disposed in an offset manner.

### SUMMARY

In order to solve the problem described above, an image reading device according to the present disclosure includes a first reading unit including a reading surface for reading a first surface of a medium transported through a transport path in a transport direction, a second reading unit disposed downstream of the first reading unit in the transport direction and including a reading surface for reading a second surface that is a surface on an opposite side of the medium from the first surface, a first transport roller pair disposed upstream of the first reading unit in the transport direction and configured to transport the medium toward the first reading unit, and a second transport roller pair disposed between the first reading unit and the second reading unit in the transport direction and configured to transport the medium toward the second reading unit, in which a tangent-line direction at a first nipping position at which the first transport roller pair nips the medium is toward a position upstream of the reading surface of the first reading unit in the transport direction, and a tangent-line direction at a second nipping position at which the second transport roller pair nips the medium is toward a position upstream of the reading surface of the second reading unit in the transport direction.

### BRIEF DESCRIPTION OF THE DRAWINGS

FIG. 1 is a schematic view illustrating a side cross-section of an image reading device according to a first embodiment.

FIG. 2 is a side cross-sectional view in which the main components of FIG. 1 are enlarged.

FIG. 3 is a schematic view illustrating a side cross-section in which the main components of FIG. 1 are enlarged.

FIG. 4 is a schematic view illustrating a side cross-section in which the main components of FIG. 3 are enlarged.

FIG. 5 is a schematic view illustrating a side cross-section in which the main components of an image reading device according to a second embodiment are enlarged.

### DESCRIPTION OF EMBODIMENTS

First, the present disclosure will be schematically described below.

An image reading device according to a first aspect of the present disclosure includes: a first reading unit including a reading surface for reading a first surface of a medium transported through a transport path in a transport direction; a second reading unit disposed downstream of the first reading unit in the transport direction and including a reading surface for reading a second surface that is a surface on an opposite side of the medium from the first surface; a first transport roller pair disposed upstream of the first reading unit in the transport direction and configured to transport the medium toward the first reading unit; and a second transport roller pair disposed between the first reading unit and the second reading unit in the transport direction and configured to transport the medium toward the second reading unit, in which a tangent-line direction at a first nipping position at which the first transport roller pair nips the medium is toward a position upstream of the reading surface of the first reading unit in the transport direction, and a tangent-line direction at a second nipping position at which the second transport roller pair nips the medium is toward a position upstream of the reading surface of the second reading unit in the transport direction.

With the present aspect, the tangent-line direction at the first nipping position at which the first transport roller pair nips the medium is toward a position upstream of the reading surface in the transport direction, and the tangent-line direction at the second nipping position at which the second transport roller pair nips the medium is toward a position upstream of the reading surface in the transport direction. With this configuration, the medium is transported in a state where force acts in a direction in which the first surface comes into contact with the reading surface of the first reading unit, and is also transported in a state where force acts in a direction in which the second surface comes into contact with the reading surface of the second reading unit. Thus, the transport posture of the medium becomes stable, and the quality of read image improves. In addition, it is possible to suppress occurrence of a transport failure state such as jamming of the medium.

The image reading device according to a second aspect of the present disclosure provides an aspect depending on the first aspect, in which the first transport roller pair includes, in side view, a first upstream roller disposed above with respect to the transport path and a second upstream roller disposed below so as to face the first upstream roller, the second transport roller pair includes, in side view, a first downstream roller above with respect to the transport path and a second downstream roller disposed below so as to face the first downstream roller, in side view, the first reading unit is disposed above with respect to the transport path and the second reading unit is disposed below, the tangent-line direction at the first nipping position is formed by disposing a rotary shaft of the second upstream roller closer to the first reading unit in the transport direction than a rotary shaft of the first upstream roller, and the tangent-line direction at the second nipping position is formed by disposing a rotary shaft of the first downstream roller closer to the second reading unit in the transport direction than a rotary shaft of the second downstream roller.

With the present aspect, when, in side view, the first reading unit is disposed above with respect to the transport path and the second reading unit is disposed below, the tangent-line direction at the first nipping position is formed by disposing the rotary shaft of the second upstream roller closer to the first reading unit in the transport direction than the rotary shaft of the first upstream roller. In addition, the tangent-line direction at the second nipping position is formed by disposing the rotary shaft of the first downstream roller closer to the second reading unit in the transport direction than the rotary shaft of the second downstream roller. This configuration makes it possible to stabilize the transport posture of the medium with a simplified structure, and to obtain an effect of improving the quality of the read image.

The image reading device according to a third aspect of the present disclosure provides an aspect depending on the first aspect, in which the first transport roller pair includes, in side view: a first upstream roller disposed above with respect to the transport path; and a second upstream roller disposed below so as to face the first upstream roller, the second transport roller pair includes, in side view: a first downstream roller disposed above with respect to the transport path; and a second downstream roller disposed below so as to face the first downstream roller, in side view, the first reading unit is disposed below with respect to the transport path and the second reading unit is disposed above, the tangent-line direction at the first nipping position is formed by disposing a rotary shaft of the first upstream roller closer to the first reading unit in the transport direction than a rotary shaft of the second upstream roller, and the tangent-line direction at the second nipping position is formed by disposing a rotary shaft of the second downstream roller closer to the second reading unit in the transport direction than a rotary shaft of the first downstream roller.

With the present aspect, when, in side view, the first reading unit is disposed below with respect to the transport path and the second reading unit is disposed above, the tangent-line direction at the first nipping position is formed by disposing the rotary shaft of the first upstream roller closer to the first reading unit in the transport direction than the rotary shaft of the second upstream roller. In addition, the tangent-line direction at the second nipping position is formed by disposing the rotary shaft of the second downstream roller closer to the second reading unit in the transport direction than the rotary shaft of the first downstream roller. This configuration makes it possible to stabilize the transport posture of the medium with a simplified structure, and to obtain an effect of improving the quality of the read image.

The image reading device according to a fourth aspect of the present disclosure provides an aspect depending on the second or third aspect, in which an angle formed by a first imaginary line and a second imaginary line perpendicular to the reading surface falls is in a range from 3 degrees to 12 degrees, the first imaginary line coupling the rotary shaft of the first upstream roller and the rotary shaft of the second upstream roller, and an angle formed by a third imaginary line and a fourth imaginary line perpendicular to the reading surface is in a range from 3 degrees to 12 degrees, the third imaginary line coupling the rotary shaft of the first downstream roller and the rotary shaft of the second downstream roller.

With the present aspect, the angle formed by the second imaginary line perpendicular to the reading surface and the first imaginary line coupling the rotary shaft of the first upstream roller and the rotary shaft of the second upstream roller is in a range from 3 degrees to 12 degrees. In addition, the angle formed by the fourth imaginary line perpendicular to the reading surface and the third imaginary line coupling the rotary shaft of the first downstream roller and the rotary shaft of the second downstream roller is in a range from 3 degrees to 12 degrees. This configuration makes it possible to transport a thick medium without deteriorating the transporting performance.

The image reading device according to a fifth aspect of the present disclosure provides an aspect depending on the first aspect, which includes: a first contact member disposed so as to face the reading surface of the first reading unit and coming into contact with the second surface of the medium; and a second contact member disposed so as to face the reading surface of the second reading unit and coming into contact with the first surface of the medium, in which the first transport roller pair transports the medium toward between the reading surface of the first reading unit and the first contact member, and the second transport roller pair transports the medium toward between the reading surface of the second reading unit and the second contact member.

Note that the present aspect can depend on any one aspect of the second to fourth aspects.

The present aspect includes: the first contact member disposed so as to face the reading surface of the first reading unit and coming into contact with the second surface of the medium; and the second contact member disposed so as to face the reading surface of the second reading unit and coming into contact with the first surface of the medium. In addition, the first transport roller pair transports the medium toward between the reading surface and the first contact member. The second transport roller pair transports the medium toward between the reading surface and the second contact member. With this configuration, since the first contact member comes into contact with the second surface of the medium and the second contact member comes into contact with the first surface of the medium, the transport posture of the medium is further stabilized, and the quality of read image further improves. Furthermore, when wrinkles occur in the medium, it is possible to smooth out the wrinkles by the first contact member and the second contact member.

The image reading device according to a sixth aspect of the present disclosure provides an aspect depending on the fifth aspect, and includes: a first rotary member disposed downstream of the first contact member in the transport direction so as to face the reading surface of the first reading unit, the first rotary member including a background member and configured to be rotatable around a shaft; and a second rotary member disposed downstream of the second contact member in the transport direction so as to face the reading surface of the second reading unit, the second rotary member including a background member and configured to be rotatable around a shaft.

With the present aspect, the first rotary member including the background member and configured to be able to rotate around the shaft is disposed downstream of the first contact member in the transport direction and at a position that is opposed to the reading surface of the first reading unit. In addition, the second rotary member including the background member and configured to be able to rotate around the shaft is disposed downstream of the second contact member in the transport direction and at a position that is opposed to the reading surface of the second reading unit. With this configuration, it is possible to stabilize the transport posture of the medium. In addition, since the background member is provided, it is possible to maintain the quality of image reading even for a transmissive medium having a relatively low thickness.

### EMBODIMENTS

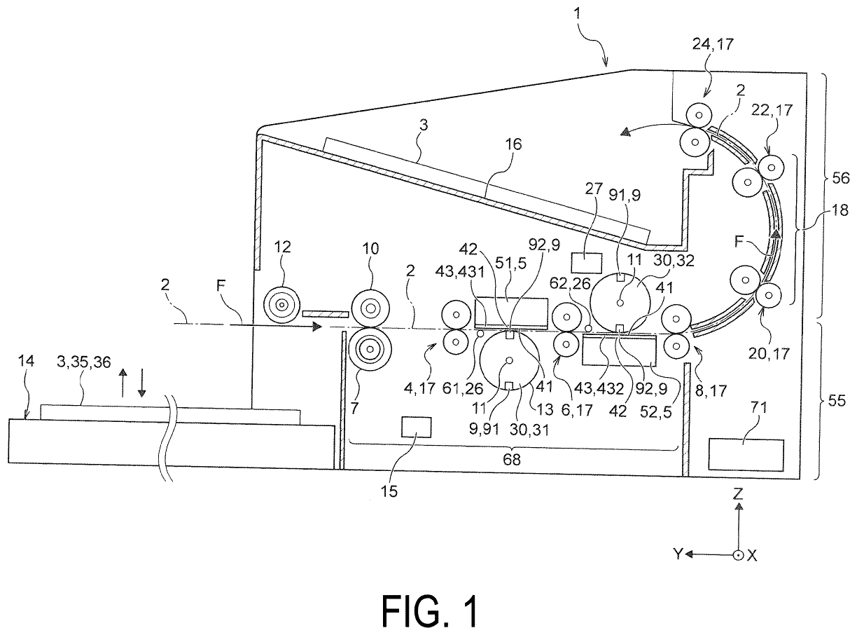

Below, embodiments of an image reading device according to the present disclosure will be specifically described with reference to FIGS. 1 to 4.

In the following description, three axes that are orthogonal to each other are referred to as an X axis, a Y axis, and a Z axis, respectively, as shown in each of the drawings. The directions pointed by the arrows of the three axes (X, Y, and Z) are +directions of the individual directions, and the opposite directions are −directions. The Z-axis direction corresponds to a vertical direction, that is, a direction in which the gravity acts. In addition, the +Z direction indicates a vertically upward direction, and the −Z direction indicates a vertically downward direction. The X-axis direction and the Y-axis direction correspond to the horizontal direction. The +Y direction indicates the forward direction of the image reading device, and the −Y direction indicates the rearward direction of this device. The +X direction indicates the rightward direction of the device, and the −X direction indicates the leftward direction of the device.

### First Embodiment

### Description of Entire Structure of Image Reading Device

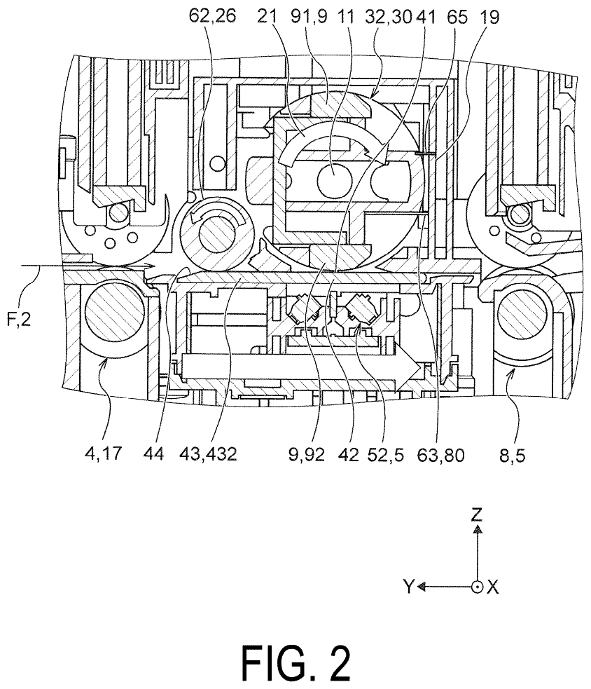

First, the entire structure of an image reading device 1 according to the first embodiment will be described with reference to FIGS. 1 and 2.

The image reading device 1 according to the present embodiment is a scanner configured to be able to read an image on a medium. Herein, the “image” means a matter visually recorded on the medium, and is, for example, a character, a figure, a table, a picture, a photograph, or the like. The medium is not limited to a sheet, and also includes a card, a booklet, and the like. The image reading device 1 is not limited to a scanner, and may be a copying machine, a facsimile machine, or the like.

As illustrated in FIG. 1, the image reading device 1 includes two reading units of a first reading unit 51 and a second reading unit 52 serving as a reading unit 5 configured to read an image on a medium 3. The first reading unit 51 and the second reading unit 52 are disposed so as to be spaced apart from each other in a transport direction F. Furthermore, the image reading device 1 includes: a first transport roller pair 4 provided upstream of the first reading unit 51 in the transport direction F and configured to transport the medium 3 along the transport path 2 in the transport direction F; a second transport roller pair 6 provided upstream of the second reading unit 52 disposed downstream of the first reading unit 51; and a third transport roller pair 8 provided downstream of the second reading unit 52.

A roller pair including a feeding roller 10 and a separation roller 7 is disposed upstream of the first transport roller pair 4 in the transport direction F. The feed roller 10 is a driving roller configured to rotate with power of a first drive source 15, and transport the medium 3 toward the transport direction F. The separation roller 7 is a driving roller that rotates with driving force of a driving source (not illustrated), and is a roller configured to separate one sheet of medium from the plurality of media 3.

Here, the separation roller 7 rotates in a direction in which the medium 3 is fed upstream (+Y direction) in the transport direction F with power of the drive source described above. The separation roller 7 includes a torque limiter (not illustrated). When a torque exceeding a predetermined value is applied to the torque limiter, the separation roller 7 is driven to rotate in a direction in which the medium 3 is fed downstream (−Y direction) in the transport direction F.

A pick roller 12 is disposed upstream of the separation roller 7. The pick roller 12 is a driving roller that rotates with the power of the first drive source 15 that is the same power as the feeding roller 10, and is configured to feed the medium 3 toward the transport direction F. The first transport roller pair 4, the second transport roller pair 6, and the third transport roller pair 8 that constitute a transport unit 17 configured to transport the medium 3 in the transport direction F also include a driving roller that rotates with power of the first drive source 15.

In the present embodiment, a curved inversion path 18 is provided downstream of a straight path 68 from the feeding roller 10 to the third transport roller pair 8, that is, downstream of the third transport roller pair 8, as illustrated in FIG. 1. In the curved inversion path 18, a fourth transport roller pair 20, a fifth transport roller pair 22, and a discharge roller pair 24 that constitute the transport unit 17 are arranged in this order along the transport direction F.

A discharge receiving unit 16 configured to receive the medium 3 discharged from the curved inversion path 18 is disposed above the straight path 68 to achieve compactness.

In FIG. 1, the reference character 71 represents a control unit. The control unit 71 controls drive of the first drive source 15 and drive of a second drive source 27 that will be described later, so as to correspond to transport of the medium 3. The first drive source 15 and the second drive source 27 are comprised of a motor.

The control unit 71 includes a CPU, a flash ROM, and an RAM. The CPU executes various types of computation processing in accordance with a program stored in the flash ROM to control operations in the entire image reading device 1. The flash ROM serving as one example of a storage unit is a readable and rewritable non-volatile memory. The RAM serving as one example of a storage unit temporarily holds various types of information.

In FIG. 1, the reference character 14 represents a medium placement unit used to place the medium 3 serving as the target of reading. The medium 3 on the medium placement unit 14 is transported through the transport path 2 and finally discharged to the discharge receiving unit 16.

The medium placement unit 14 is configured to move up and down. When the medium 3 placed on the medium placement unit 14 is sent in the transport direction F, power is first transmitted from a drive source (not illustrated) to the medium placement unit 14 to be moved upward (+Z direction), and the uppermost one of the media 3 having been placed is stopped in a state of being in contact with the pick roller 12. As the pick roller 12 rotates in this state, the medium 3 is sent in the transport direction F, and the leading end of the medium 3 reaches a nipping position of the roller pair of the feeding roller 10 and the separation roller 7.

In a case of a multiple-feed state in which the plurality of media 3 are sent, the separation roller 7 separates one medium from the media, and this one medium is transported in the transport direction F by the first transport roller pair 4, and the first reading unit 51 reads an image on a first surface 35 of the medium 3. In addition, the medium 3 for which reading has been performed by the first reading unit 51 is transported by the second transport roller pair 6, and the second reading unit 52 reads an image on a second surface 36 at an opposite side from the first surface 35 of the medium 3.

The medium 3 for which reading has been performed by the second reading unit 52 is transported by the third transport roller pair 8, and is discharged to the discharge receiving unit 16 by the discharge roller pair 24.

As illustrated in FIGS. 1 and 2, in the present embodiment, the first reading unit 51 and second reading unit 52 that read an image on the medium 3 that is transported in the transport direction F include a first light-transmissive member 431 and a second light-transmissive member 432 each serving as a light-transmissive member 43 disposed between the transport path 2 and the first reading unit 51 or the second reading unit 52. The reference character 41 represents a reading surface of the reading unit 5.

In FIG. 2, the reference character 42 represents a reading position of the second reading unit 52, and the reference character 44 represents a sloped surface. The sloped surface 44 is provided at an upstream end portion on the reading surface 41 side of the light-transmissive member 43, and guides the medium 3 so as to move in a direction along the transport path 2 when the leading end of the medium 3 that is being transported comes into contact with the sloped surface. The reading unit 5 includes a contact image sensor (CIS)-type sensor that extends along the X-axis or a charge coupled device (CCD) or the like, for example.

### Rotary Member

As illustrated in FIGS. 1 and 2, a first rotary member 31 and a second rotary member 32 that serve as a rotary member 30 are disposed at an opposite side from the first reading unit 51 and the second reading unit 52 of the first light-transmissive member 431 and the second light-transmissive member 432. The first rotary member 31 and the second rotary member 32 are rotary members disposed so as to face the first reading unit 51 and the second reading unit 52, and are configured to be able to rotate around a shaft 11. The reference character 21 represents a rotational direction. The first rotary member 31 and the second rotary member 32 each have a substantially tubular shape, and are formed so as to have a length that makes it possible to cover a range (X-axis direction) in which the first reading unit 51 and the second reading unit 52 read.

In the present embodiment, the first rotary member 31 and the second rotary member 32 include a background member 9 and a second cleaning unit 63, as illustrated in FIG. 2. The second cleaning unit 63 is attached to the rotary member 30 in a state where the tip portion of the member protrudes from an outer peripheral surface 13 of the rotary member 30. As the rotary member 30 rotates in the rotational direction 21, that is, rotates around the shaft 11, the second cleaning unit 63 wipes, that is, cleans the reading surface 41. The background member 9 includes two background members of a first background member 91 and a second background member 92 so as to be arranged as illustrated in FIG. 2. In addition, the background member 9 includes a first cleaning unit 65 that is able to clean the first background member 91 and the second background member 92.

In the present embodiment, the first background member 91 creates a white background. The second background member 92 creates a black background. Note that the colors are not limited to these colors. The colors of the members are only necessary to be a combination of colors having different contrasts. The first cleaning unit 65 cleans the first background member 91 and the second background member 92. Here, the first cleaning unit 65 is a brush having a base end fixed to a frame 19 comprised of a structural element of an upper unit 56 (FIG. 1) that will be described later. Note that FIG. 2 is a diagram in which a portion of the second reading unit 52 is enlarged, and hence, the first rotary member 31 cannot be seen.

In addition, the first rotary member 31 and the second rotary member 32 rotate around the shaft 11 with power of the second drive source 27, which is a common drive source. The rotational operations of the first rotary member 31 and the second rotary member 32 are controlled by the control unit 71. The second drive source 27 transmits the power to the first rotary member 31 and the second rotary member 32 through a power transmission mechanism that is not illustrated in the drawing, and causes these rotary members to rotate.

Note that the first rotary member 31 and the second rotary member 32 may be configured to rotate with power of individual motors, rather than the common second drive source 27.

The first reading unit 51, the first light-transmissive member 431, and the second rotary member 32 are disposed above the transport path 2. The second reading unit 52, the second light-transmissive member 432, and the first rotary member 31 are disposed below the transport path 2.

In the present embodiment, the image reading device 1 includes a lower unit 55 and the upper unit 56, as illustrated in FIG. 1. The upper unit 56 is configured to vertically turn with respect to the lower unit 55 by an opening-closing mechanism (not illustrated) so as to be able to be opened and closed.

The lower unit 55 includes the second reading unit 52, the second light-transmissive member 432, and the first rotary member 31. The upper unit 56 includes the first reading unit 51, the first light-transmissive member 431, and the second rotary member 32. In addition, in a state where the upper unit 56 is closed with respect to the lower unit 55, the second light-transmissive member 432 and the second rotary member 32 are disposed so as to face each other, and the first light-transmissive member 431 and the first rotary member 31 are disposed so as to face each other, as illustrated in FIG. 1.

Although illustration is not given, in a state where the upper unit 56 is opened with respect to the lower unit 55, configuration is made such that the second light-transmissive member 432 and the second rotary member 32 are not opposed to each other, and the first light-transmissive member 431 and the first rotary member 31 are not opposed to each other. That is, opposing surfaces of the lower unit 55 and the upper unit 56 are turned into an exposed state, which allows a user to access there.

The present embodiment includes a first contact member 61 and a second contact member 62 disposed upstream of the first rotary member 31 and the second rotary member 32 so as to face the first light-transmissive member 431 and the second light-transmissive member 432, and serve as a contact member configured to help transporting the medium 3, as illustrated in FIGS. 1 to 3. Here, the first contact member 61 and the second contact member 62 are comprised of a driving roller referred to as a platen roller 26 configured to rotate with power of the first drive source 15 that is transmitted thereto.

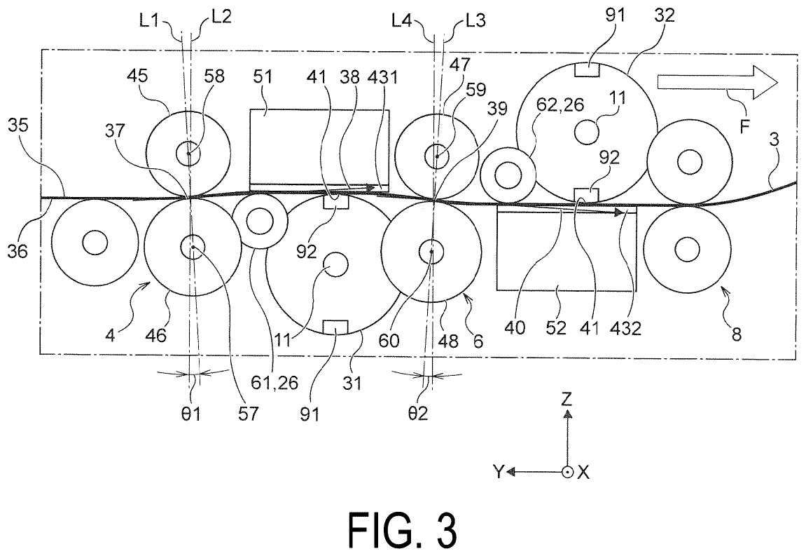

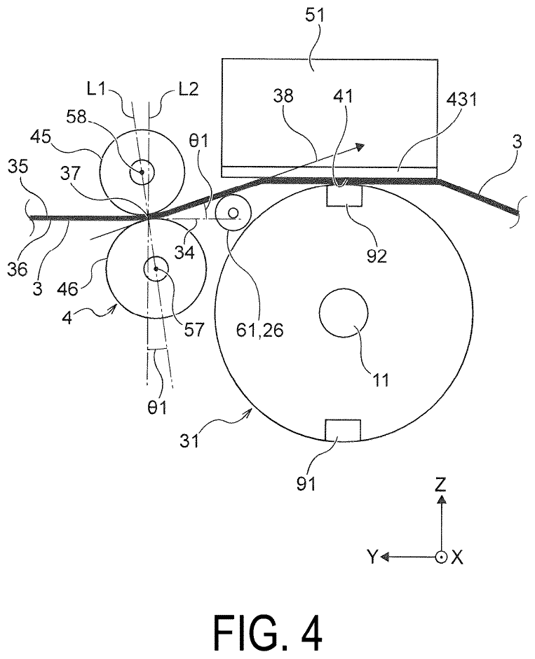

Next, one of the main components of the image reading device 1 according to the first embodiment will be described with reference to FIGS. 3 and 4.

As illustrated in FIG. 3, the image reading device 1 according to the present embodiment includes the first reading unit 51 including the reading surface 41 for reading the first surface 35 of the medium 3 transported through the transport path 2 in the transport direction F. In addition, the image reading device 1 includes the second reading unit 52 disposed downstream of the first reading unit 51 in the transport direction F and including the reading surface 41 for reading the second surface 36 that is a surface on an opposite side of the medium 3 from the first surface 35. Furthermore, the image reading device 1 includes the first transport roller pair 4 disposed upstream of the first reading unit 51 in the transport direction F and configured to transport the medium 3 toward the first reading unit 51. In addition, the image reading device 1 includes the second transport roller pair 6 disposed between the first reading unit 51 and the second reading unit 52 in the transport direction and configured to transport the medium 3 toward the second reading unit 52.

Furthermore, a tangent-line direction 38 at a first nipping position 37 where the first transport roller pair 4 nips the medium 3 is configured so as to head toward a position upstream of the reading surface 41 of the first reading unit 51 in the transport direction F.

In addition, a tangent-line direction 40 at a second nipping position 39 where the second transport roller pair 6 nips the medium 3 is configured so as to head toward a position upstream of the reading surface 41 of the second reading unit 52 in the transport direction F.

In the present embodiment, in side view, the first reading unit 51 is disposed above with respect to the transport path 2, and the second reading unit 52 is disposed below, as illustrated in FIGS. 1 and 3.

In addition, in the present embodiment, the first transport roller pair 4 includes, in side view, a first upstream roller 45 disposed above with respect to the transport path 2, and a second upstream roller 46 disposed below so as to face the first upstream roller 45.

Furthermore, the second transport roller pair 6 includes, in side view, a first downstream roller 47 disposed above with respect to the transport path 2, and a second downstream roller 48 disposed below so as to face the first downstream roller 47.

In addition, the tangent-line direction 38 at the first nipping position 37 is formed by disposing the central position of a rotary shaft 57 of the second upstream roller 46 so as to be positionally shifted more toward the first reading unit 51 side (−Y side) than the central position of a rotary shaft 58 of the first upstream roller 45, as illustrated in FIG. 3.

Furthermore, the tangent-line direction 40 at the second nipping position 39 is formed by disposing the central position of a rotary shaft 59 of the first downstream roller 47 so as to be positionally shifted more toward the second reading unit 52 side (−Y side) than the central position of a rotary shaft 60 of the second downstream roller 48.

In the present embodiment, when the “11” represents an angle formed by a first imaginary line L1 coupling the central position of the rotary shaft 58 of the first upstream roller 45 and the central position of the rotary shaft 57 of the second upstream roller 46 and a second imaginary line L2 perpendicular to the reading surface 41 of the first reading unit 51, the angle θ1 is in a range from 3 degrees to 12 degrees with consideration of the thickness of the medium 3, that is, the rigidity of the medium, as illustrated in FIG. 3. In addition, when the “θ2” represents an angle formed by a third imaginary line L3 coupling the central position of the rotary shaft 59 of the first downstream roller 47 and the central position of the rotary shaft of the second downstream roller 48 and a fourth imaginary line L4 perpendicular to the reading surface 41 of the second reading unit 52, the angle θ2 is in a range from 3 degrees to 12 degrees with consideration of the thickness of the medium 3, that is, the rigidity of the medium.

FIG. 4 is a diagram in which a portion including the first reading unit 51 and the first transport roller pair 4 is enlarged and the “positional shift” described above is exaggerated. As illustrated in FIG. 4, an angle formed by the tangent-line direction 38 and a surface 34 parallel to the reading surface 41, that is, an angle of the tangent-line direction 38 at the nipping position 37 is also θ1.

An angle formed by the tangent-line direction 40 and the surface 34 parallel to the reading surface 41, that is, an angle of the tangent-line direction 40 at the nipping position 39 is also θ2.

The present embodiment includes the first contact member 61 disposed so as to face the reading surface 41 of the first reading unit 51 and coming into contact with the second surface 36 of the medium 3, as illustrated in FIGS. 1 to 4. In addition, the present embodiment includes the second contact member 62 disposed so as to face the reading surface 41 of the second reading unit 52 and coming into contact with the first surface 35 of the medium 3.

Furthermore, the first transport roller pair 4 is configured to transport the medium 3 toward between the reading surface 41 of the first reading unit 51 and the first contact member 61. In addition, the second transport roller pair 6 is configured to transport the medium 3 toward between the reading surface 41 of the second reading unit 52 and the second contact member 62.

Note that, apart from the platen roller 26, the first contact member 61 and the second contact member 62 can replace it with a method such as a pressing plate, wind pressure, electrostatic absorption, or the like.

Although this is repetitive description, the present embodiment includes the first rotary member 31 disposed downstream of the first contact member 61 in the transport direction F so as to face the reading surface 41 of the first reading unit 51, as illustrated in FIGS. 1 to 4. The first rotary member 31 includes the background member 9 and is configured so as to be able to rotate around the shaft 11.

In addition, there is provided the second rotary member 32 disposed downstream of the second contact member 62 in the transport direction F so as to face the reading surface 41 of the second reading unit 52. The second rotary member 32 includes the background member 9 and is configured so as to be able to rotate around the shaft 11.

As described above, the background member 9 includes two members of the first background member 91 having white color and the second background member 92 having black color. However, these are not limited to a combination of white color and black color.

### Description of Effects of First Embodiment

(1) In the present embodiment, the tangent-line direction 38 at the first nipping position 37 where the first transport roller pair 4 nips the medium 3 is toward a position upstream of the reading surface 41 of the first reading unit 51 in the transport direction F, and the tangent-line direction 40 at the second nipping position 39 where the second transport roller pair 6 nips the medium 3 is toward a position upstream of the reading surface 41 of the second reading unit 52 in the transport direction F. With this configuration, the medium 3 is transported in a state where force acts in a direction in which the first surface 35 comes into contact with the reading surface 41 of the first reading unit 51, and is also transported in a state where force acts in a direction in which the second surface 36 comes into contact with the reading surface 41 of the second reading unit 52. Thus, the transport posture of the medium 3 is stabilized, and the quality of read image improves. In addition, it is possible to suppress occurrence of a transport failure state such as jamming of the medium 3.

(2) In addition, in the present embodiment, when, in side view, the first reading unit 51 is disposed above with respect to the transport path 2 and the second reading unit 52 is disposed below, the tangent-line direction 38 at the first nipping position 37 is formed by disposing the rotary shaft 57 of the second upstream roller 46 so as to be positionally shifted more toward the side of the first reading unit 51 than the rotary shaft 58 of the first upstream roller 45, as illustrated in FIGS. 1 and 3. In addition, the tangent-line direction 40 at the second nipping position 39 is formed by disposing the rotary shaft 59 of the first downstream roller 47 so as to be positionally shifted more toward a side of the second reading unit 52 than the rotary shaft 60 of the second downstream roller 48. This configuration makes it possible to stabilize the transport posture of the medium 3 with a simplified structure, and to obtain an effect of improving the quality of the read image.

(3) Furthermore, in the present embodiment, the angle θ1 formed by the first imaginary line L1 coupling the rotary shaft 58 of the first upstream roller 45 and the rotary shaft 57 of the second upstream roller 46 and the second imaginary line L2 perpendicular to the reading surface 41 is in a range from 3 degrees to 12 degrees. In addition, the angle θ2 formed by the third imaginary line L3 coupling the rotary shaft 59 of the first downstream roller 47 and the rotary shaft 60 of the second downstream roller 48 and the fourth imaginary line L4 perpendicular to the reading surface 41 is in a range from 3 degrees to 12 degrees. This configuration makes it possible to transport a thick medium 3 without deteriorating the transporting performance.

(4) Furthermore, the present embodiment includes the first contact member 61 disposed so as to face the reading surface 41 of the first reading unit 51 and coming into contact with the second surface 36 of the medium 3, and also includes the second contact member 62 disposed so as to face the reading surface 41 of the second reading unit 52 and coming into contact with the first surface 35 of the medium 3. In addition, the first transport roller pair 4 transports the medium 3 toward between the reading surface 41 and the first contact member 61, and the second transport roller pair 6 transports the medium 3 toward between the reading surface 41 and the second contact member 62. With this configuration, the first contact member 61 and the second surface 36 of the medium 3 come into contact with each other, and the second contact member 62 and the first surface 35 of the medium 3 come into contact with each other. This makes it possible to further stabilize the transport posture of the medium 3 and further improve the quality of read image. Furthermore, when wrinkles occur in the medium 3, it is possible to smooth out the wrinkles by the first contact member 61 and the second contact member 62.

(5) In addition, in the present embodiment, the first rotary member 31 including the background member 9 and configured so as to be able to rotate around the shaft 11 is disposed downstream of the first contact member 61 in the transport direction F so as to face the reading surface 41 of the first reading unit 51. Furthermore, the second rotary member 32 including the background member 9 and configured so as to be able to rotate around the shaft 11 is disposed downstream of the second contact member 62 in the transport direction F so as to face the reading surface 41 of the second reading unit 52. With this configuration, it is possible to stabilize the transport posture of the medium 3. In addition, since the background member 9 is provided, it is possible to maintain the quality of image reading even for a transmissive medium 3 having a relatively small thickness.

### Second Embodiment

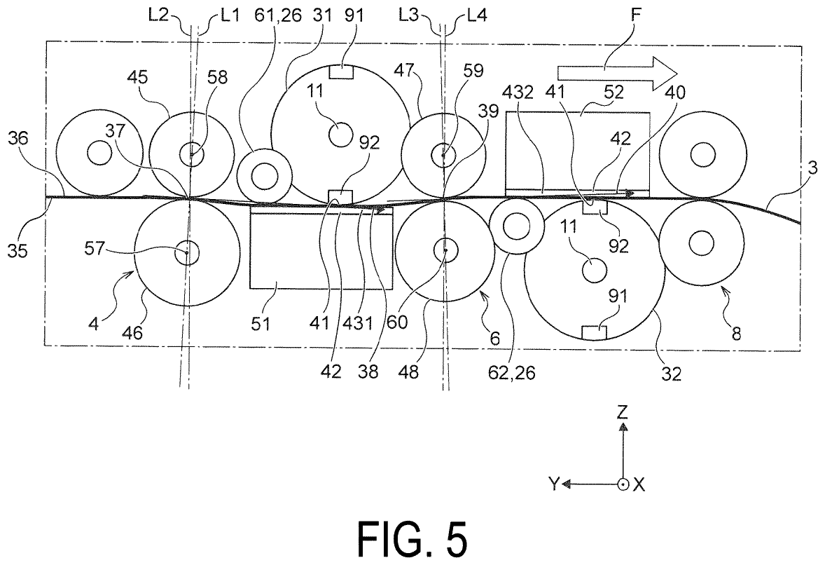

Next, an image reading device 1 according to a second embodiment will be described with reference to FIG. 5. The same reference characters are attached to the same portions as those in the first embodiment, and explanation of the configurations thereof and the corresponding effects will not be repeated.

In the present embodiment, in side view, the first reading unit 51 is disposed at a lower side relative to the transport path 2, and the second reading unit 52 is disposed below, as illustrated in FIG. 5. That is, the first reading unit 51 and the second reading unit 52 are disposed so as to be inverted upside down from the first embodiment.

In addition, although this is repetitive description, in the present embodiment, the first transport roller pair 4 includes, in side view, the first upstream roller 45 disposed above with respect to the transport path 2, and the second upstream roller 46 disposed at a lower side so as to face the first upstream roller, as with the first embodiment.

Furthermore, in side view, the second transport roller pair 6 includes the first downstream roller 47 disposed above with respect to the transport path 2, and the second downstream roller 48 disposed at a lower side so as to face the first downstream roller 47.

Furthermore, the tangent-line direction 38 at the first nipping position 37 is formed by disposing the central position of the rotary shaft 58 of the first upstream roller 45 so as to be positionally shifted more toward the first reading unit 51 side (−Y side) than the central position of the rotary shaft 57 of the second upstream roller 46, as illustrated in FIG. 5.

In addition, the tangent-line direction 40 at the second nipping position 39 is formed by disposing the central position of the rotary shaft 60 of the second downstream roller 48 so as to be positionally shifted more toward the second reading unit 52 side (−Y side) than the central position of the rotary shaft 59 of the first downstream roller 47.

In the present embodiment, when, in side view, the first reading unit 51 is disposed at a lower side relative to the transport path 2 and the second reading unit 52 is disposed above, the tangent-line direction 38 at the first nipping position 37 is formed by disposing the rotary shaft 58 of the first upstream roller 45 so as to be positionally shifted more toward the first reading unit 51 side than the rotary shaft 57 of the second upstream roller 46, as illustrated in FIG. 5. Furthermore, the tangent-line direction 40 at the second nipping position 39 is formed by disposing the rotary shaft 60 of the second downstream roller 48 more toward the second reading unit 52 side than the rotary shaft 59 of the first downstream roller 47. This configuration makes it possible to stabilize the transport posture of the medium 3 with a simplified structure, and to obtain the effect of improving the quality of the read image.

### OTHER EMBODIMENTS

The image reading device 1 according to the present disclosure is based on the configuration of the embodiments described above. However, it is of course possible to partially change or omit a configuration within the scope not departing from the gist of the present disclosure.

In the description above, the first reading unit 51 and the second reading unit 52 are disposed so as to be spaced apart from each other in the Y-axis direction that is the horizontal direction. However, the arrangement of these units is not limited to this. For example, the first reading unit 51 and the second reading unit 52 may have a structure in which these units are disposed so as to be spaced apart from each other in the Z-axis direction that is the vertical direction, that is, they are offset.

What is claimed is:

1. An image reading device, comprising:
a first reading unit including a reading surface for reading a first surface of a medium transported through a transport path in a transport direction;
a second reading unit disposed downstream of the first reading unit in the transport direction and including a reading surface for reading a second surface that is a surface on an opposite side of the medium from the first surface;
a first transport roller pair disposed upstream of the first reading unit in the transport direction and configured to transport the medium toward the first reading unit; and
a second transport roller pair disposed between the first reading unit and the second reading unit in the transport direction and configured to transport the medium toward the second reading unit, wherein
a tangent-line direction at a first nipping position at which the first transport roller pair nips the medium is toward a position upstream of the reading surface of the first reading unit in the transport direction, and
a tangent-line direction at a second nipping position at which the second transport roller pair nips the medium is toward a position upstream of the reading surface of the second reading unit in the transport direction.

2. The image reading device according to claim 1, wherein
the first transport roller pair includes, in side view, a first upstream roller disposed above with respect to the transport path, and a second upstream roller disposed below with respect to the transport path so as to face the first upstream roller,
the second transport roller pair includes, in side view, a first downstream roller disposed above with respect to the transport path, and a second downstream roller disposed below with respect to the transport path so as to face the first downstream roller,
in side view, the first reading unit is disposed above with respect to the transport path and the second reading unit is disposed below with respect to the transport path,
the tangent-line direction at the first nipping position is formed by disposing a rotary shaft of the second upstream roller closer to the first reading unit in the transport direction than a rotary shaft of the first upstream roller, and
the tangent-line direction at the second nipping position is formed by disposing a rotary shaft of the first downstream roller closer to the second reading unit in the transport direction than a rotary shaft of the second downstream roller.

3. The image reading device according to claim 1, wherein
the first transport roller pair includes, in side view, a first upstream roller disposed above with respect to the transport path, and a second upstream roller disposed below with respect to the transport path so as to face the first upstream roller,
the second transport roller pair includes, in side view, a first downstream roller disposed above with respect to the transport path, and a second downstream roller disposed below with respect to the transport path so as to face the first downstream roller,
in side view, the first reading unit is disposed at a lower side relative to the transport path, and the second reading unit is disposed at an upper side,
the tangent-line direction at the first nipping position is formed by disposing a rotary shaft of the first upstream roller closer to the first reading unit in the transport direction than a rotary shaft of the second upstream roller, and
the tangent-line direction at the second nipping position is formed by disposing a rotary shaft of the second downstream roller closer to the second reading unit in the transport direction than a rotary shaft of the first downstream roller.

4. The image reading device according to claim 2, wherein
an angle formed by a first imaginary line and a second imaginary line is in a range from 3 degrees to 12 degrees, the first imaginary line coupling the rotary shaft of the first upstream roller and the rotary shaft of the second upstream roller (through the first nipping position of the first transport roller pair), the second imaginary line being perpendicular to the reading surface of the first reading unit, and
an angle formed by a third imaginary line and a fourth imaginary line is in a range from 3 degrees to 12 degrees, the third imaginary line coupling the rotary shaft of the first downstream roller and the rotary shaft of the second downstream roller (through the second nipping position of the second transport roller pair), the fourth imaginary line being perpendicular to the reading surface of the second reading unit.

5. The image reading device according to claim 1, comprising:
a first contact member disposed so as to face the reading surface of the first reading unit and coming into contact with the second surface of the medium; and
a second contact member disposed so as to face the reading surface of the second reading unit and coming into contact with the first surface of the medium, wherein
the first transport roller pair transports the medium toward between the reading surface of the first reading unit and the first contact member, and
the second transport roller pair transports the medium toward between the reading surface of the second reading unit and the second contact member.

6. The image reading device according to claim 5, comprising:
a first rotary member facing the reading surface of the first reading unit, disposed downstream of the first contact member in the transport direction, and being rotatable about a shaft by including a background member; and
a second rotary member facing the reading surface of the second reading unit, disposed downstream of the second contact member in the transport direction, and being rotatable about a shaft by including a background member.
